(19) United States
(12) Patent Application Publication
(10) Pub. No.: US 2018/0097989 A1
(43) Pub. Date: Apr. 5, 2018

(54) SMARTPHONE CAMERA CASE

(71) Applicant: PIXL Toys, Inc., San Francisco, CA (US)

(72) Inventor: John Paul Stoops, San Francisco, CA (US)

(21) Appl. No.: 15/588,525

(22) Filed: May 5, 2017

Related U.S. Application Data
(60) Provisional application No. 62/304,174, filed on Mar. 5, 2016.

(51) Int. Cl. H04N 5/232; H04N 5/225; H04B 1/3888

(52) U.S. Cl. CPC H04N 5/23216; H04N 5/23293; H04B 1/3888; H04N 5/23203; H04N 5/2252

(57) ABSTRACT

A device to encase a smartphone is provided. The smartphone has an input component. A case member encases the smartphone at least in part, a first opening in the case member providing touch access to the smartphone through a transparent window. A second opening surrounds a camera lens of the smartphone. A control mechanism on an external surface of the case member is linked via an interface component to a smartphone control of the smartphone. The control mechanism is configured to operate at least one function of the smartphone. The interface component is configured to receive a user input from the control mechanism and pass a corresponding input to the smartphone control of the smartphone.

### CROSS REFERENCE TO RELATED APPLICATION

This application claims the benefit of U.S. Provisional Patent Application Ser. No. 62/304,174, filed Mar. 5, 2016, entitled SMARTPHONE CAMERA CASE, the entire contents of which are herein incorporated by reference.

### TECHNICAL FIELD

The present application relates to the field of smartphone cameras and smartphone camera cases.

### BACKGROUND

Smartphones currently offer an array of functions and customizable features. Camera capabilities provide a smartphone user with the ability to take high-quality pictures and store large amounts of media data. Interactive applications may allow a user to engage in games or learning activities. Smartphone applications may be geared to users of all ages. Younger users may benefit from learning applications and harnessing smartphone tools for learning activities. However, smartphone design is currently intended for adult users.

### SUMMARY

A device to encase a smartphone is provided. The smartphone has an input component. A case member encases the smartphone at least in part. A first opening in the case member may provide touch access to the smartphone through a transparent window. A second opening may surround a camera lens of the smartphone. A control mechanism may be on an external surface of the case member and may be linked via an interface component to a smartphone control of the smartphone. The control mechanism may be configured to operate at least one function of the smartphone. The interface component may be configured to receive a user input from the control mechanism and pass a corresponding input to the smartphone control of the smartphone.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is an illustration of a device to encase a smartphone.

FIGS. 2A and 2B depict two views of the back of the device, where FIG. 2A shows the interior of the device in which a smartphone may be accommodated and FIG. 2B shows a screen covering the interior of the device.

FIG. 3 depicts a back of the device where a first part is in an open configuration and an interior of the device may be viewed.

FIG. 4 replicates FIG. 3 and additionally depicts the placement of a smartphone in the device.

FIGS. 5A and 5B illustrate two views of the device, where FIG. 5A shows the top of the device and FIG. 5B shows the front of the device.

FIG. 6 is a schematic of the device components summarizing implementation with a smartphone.

FIG. 7 is a flowchart of a method for manufacturing a device to encase a smartphone, according to an example implementation.

### DETAILED DESCRIPTION

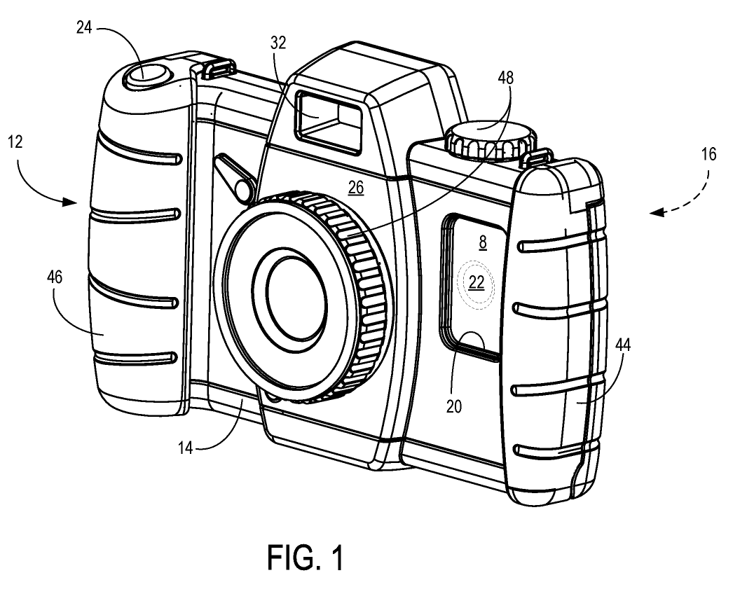

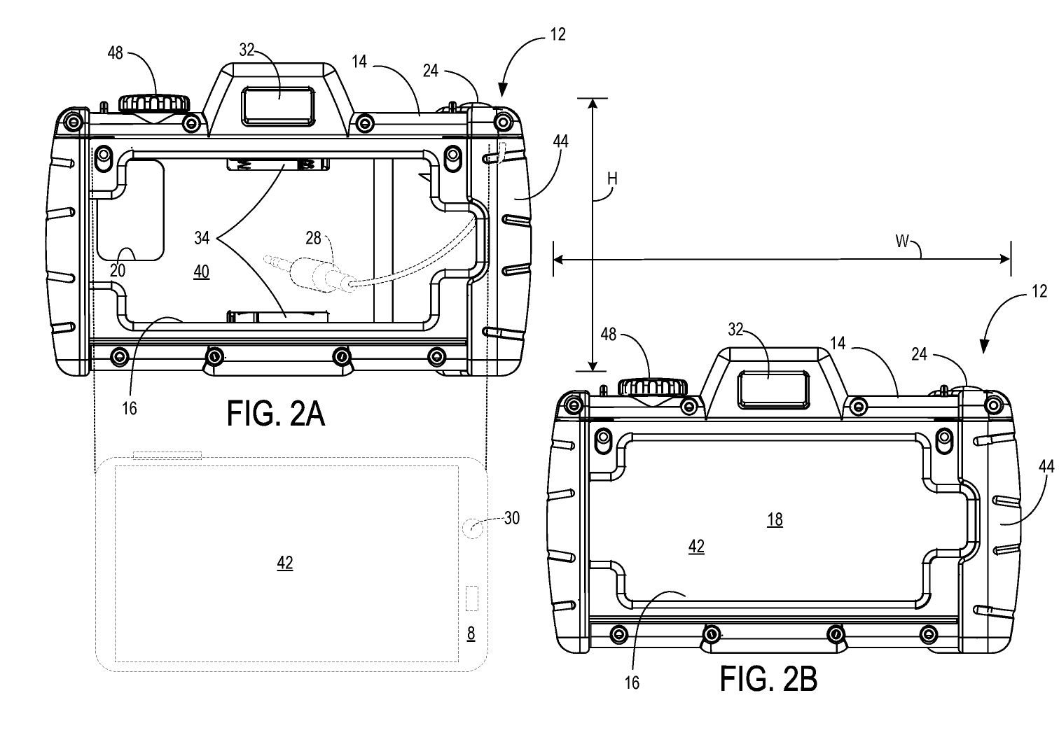

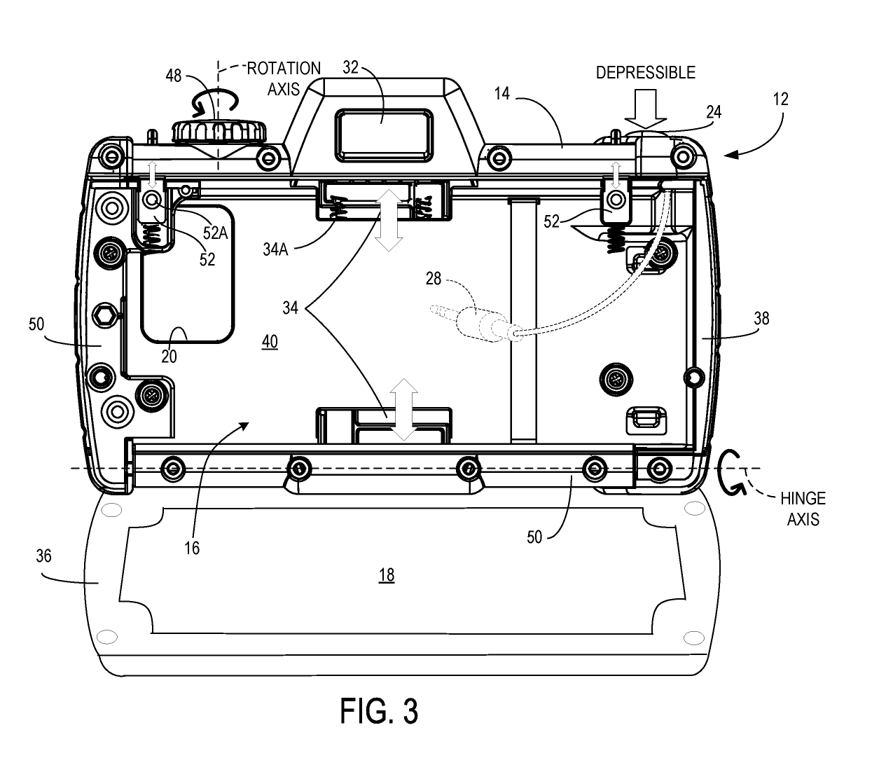

A device 12 that encases a smartphone 8 having an input component is provided. FIG. 1 illustrates a case member 14 that is a second unit, the case member 14 designed to encase a smartphone 8 at least in part. A first opening 16 that may be a first hole in the case member 14 may provide touch access to the smartphone 8 through a transparent window 18 that is a first unit. In one implementation, the first opening 16 is located on the back side of the case member 14, as shown in FIG. 2A. A second opening 20 that may be a second hole surrounding a camera lens 22 of the smartphone 8 may also be constructed. A control mechanism 24 on an external surface 26 of the case member 14 may be linked via an interface component 28 to a smartphone control 30 of the smartphone 8. In the illustrated embodiment, the smartphone control 30 is a software component of the smartphone 8 run via an application on the smartphone 8, which controls a smart phone function such as shutter operation of the camera. Upon depression of the button corresponding to the control mechanism 24, a signal is sent via the interface component (e.g., audio or LIGHTNING connector) to the software smartphone control 30, which causes an operation such as a camera shutter operation to be executed. Alternatively, the smartphone control 30 may be a physical control on the smartphone, such as a mechanically depressible button 30A configured to be depressed by a control mechanism such as button 24A, as shown in dashed lines in FIG. 2A. Thus, it will be appreciated that the interface component 28 may be configured to operate either a hardware component or a software component of the smartphone 8. By these means, the control mechanism 24 may be configured to operate at least one function of the smartphone 8. The interface component 28 may be configured to receive a user input from the control mechanism 24 and pass a corresponding input to the smartphone control 30 of the smartphone 8. In one implementation, the control mechanism 24 may be one of a plurality of control mechanisms 24 on the external surface 26 of the case member 14, each configured to operate a respective smartphone control 30 via the interface component 28. The interface component 28 may be a touchscreen 42 of the smartphone 8, an audio jack as depicted in FIGS. 2A and 3, a LIGHTNING connector, or a wireless connection via, for example, BLUETOOTH.

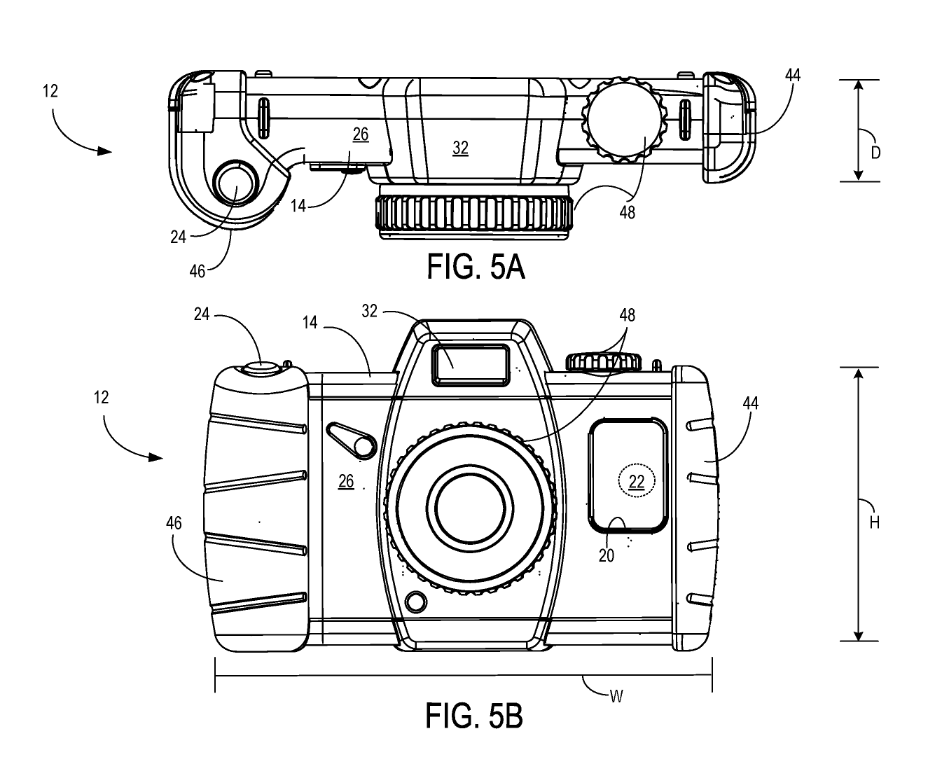

FIGS. 2A and 2B give, in one implementation, dimensions of the device 12. In the height direction the device 12 may have a height H of between 8 and 12 cm and preferably 10 cm, and in the width direction the device 12 may be have a width W of between 14 and 20 cm, and preferably 17 cm. Additionally, FIG. 5A illustrates a depth D of the device in a depth direction, which may be between 2 and 4 cm, and which is preferably 3 cm in one embodiment. These dimensions are merely exemplary, as it will be appreciated that the device 12 may be sized to accommodate a variety of sizes of smartphones 8 within the interior 40 of the device 12, as described below.

The control mechanism 24 may be a button that activates the function of the smartphone 8 via the interface component 28, as depicted in FIGS. 1 and 2A. Alternatively, the control mechanism 24 may be a switch, dial, knob, or other moving part synchronized with a function of the smartphone. The function of the smartphone 8 may be a shutter operation of a camera having camera lens 22 of the smartphone 8. In this way, a user such as a child may use the device 12 to control the shutter operation and take pictures with the smartphone 8 held inside the device. Alternatively, a dial on the external surface 26 of the device 12 may be configured to control a zoom property of a smartphone camera function. In one example implementation, a knob on the external surface 26 of the device 12 may be configured to sequentially rotate differently colored filters over the camera lens 22. External controls on device 12 operatively linked via an interface component 28 to control other operations may also be provided, such as for toggling through pictures that have been taken on the camera, applying effects to pictures, deleting pictures, etc.

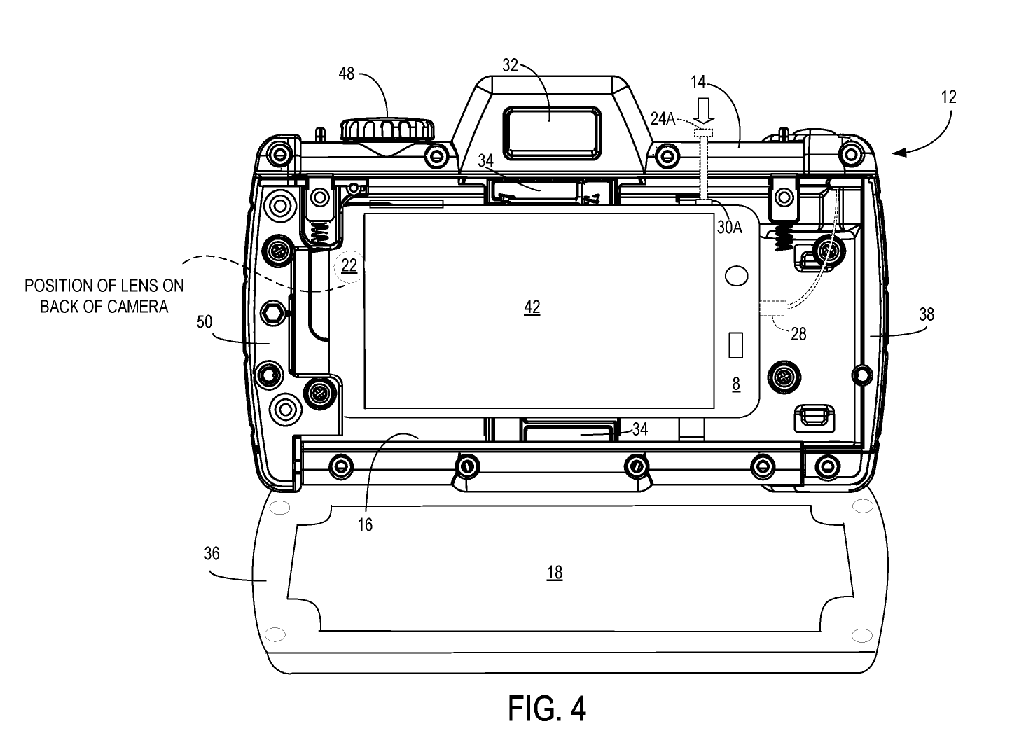

A viewfinder 32 may be formed in the external surface 26 of the case member 14, which is configured to allow a user to compose a picture to be taken via the camera of the smartphone 8. FIG. 2A shows an interior securing member 34 enclosed by the case member 14, the interior securing member 34 configured to adjustably encase a plurality of smartphone sizes. The interior securing member 34 may be a flexible wheel assembly unit, a spring-loaded unit, a clamping mechanism, or at least one elastic band. In the illustrated embodiment, a pair of interior securing members 34 are provided on a top and a bottom of an interior chamber in the interior 40 of the device 12. The securing members are biased inwardly by coil springs 34A provided therein, and have flat surfaces with a shape that is designed to clamp against and edge of the smartphone 8. To insert a smartphone 8 into the interior 40, the user positions the smartphone 8 against one of the interior securing members 34 and presses against the bias force until the interior securing member 34 is retracted sufficiently, which provides clearance for the opposite edge of the smartphone 8 to be inserted against the other of the interior securing members 34. Once inserted, the interior securing members 34 clamp in opposing directions to securely hold the smartphone 8 within the interior 40, in the configuration shown in FIG. 4, discussed below. FIG. 2B shows device 12 in the same orientation as in FIG. 2A, with the addition of a screen 42 of smartphone 8 visible through the transparent window 18, which hides the interior 40 of the device 12 from view.

The case member 14 may include at least a first part 36 and a second part 38 that are securely attached in a manner that allows opening and closing of the second part 38 relative to the first part 36, as shown in FIG. 3. The first part 36 serves as a back cover that is openable and closeable via an attachment mechanism to allow access to the interior 40 of the device 12. The second part 38 is a front body of the device 12 formed in the shape of a toy camera, which has a concavity formed therein to form the interior 40 of the device 12. It should be noted that FIG. 3 depicts a back of the device where a first part 36 is in an open configuration and an interior 40 of the device may be viewed. In this configuration, a left casing 50 is shown; although a right casing may also be present, it is not shown in FIG. 3 to instead make the connection of an interface component 28 visible. The attachment mechanism is typically a hinge, but alternatively may be or include a latching mechanism, a pin, a reusable adhesive mechanism, hoop and loop fasteners, or frictional contact. It will be appreciated that the first part 36 may be connected to the window 18 via springs to allow the window 18 to compress against different sized smartphones 8. In one implementation, a sealing material may be formed on the interior 40 of the case member 14 that is configured to seal the interior 40 of the device 12 and inhibit movement of the smartphone 8 within the interior 40. It will be appreciated that a configuration with sealing material may protect the device from external elements such as water to varying degrees. In one implementation, a protective cover may be positioned in at least one of the openings 16 and 20 to cover a touchscreen 42 and/or camera lens 22 of the smartphone 8.

FIG. 4 shows device 12 in an orientation similar to FIG. 3, and additionally shows the placement of the smartphone 8 in the interior 40 and held in place by the interior securing members 34. As described above, the gripping surfaces of the securing members are movable in and out against the bias force of coil springs 34A to function as a centering clamp on smartphone 8. The gripping surfaces (inner edge surfaces in a height direction in FIG. 4) of the securing members 34 thus can accommodate smartphones of varying dimension within the interior 40 of the device 12. The interior securing members 34 may be designed to retract and extend through a range of displacement, thus allowing for a larger or smaller smartphone to fit within the device 12.

The external surface 26 of the device 12 may include handles 44 as shown in FIG. 1. Alternatively or in addition, a texture on the external surface 26 of the device 12 configured to increase friction between a user's hand and the device 12 may be implemented. At least one bumper 46 may be included on the external surface 26 of the device 12, the bumper 46 being configured to absorb shock from impact forces should the device 12 be dropped or otherwise collided with another object. In one implementation, to foster learning and play activity, a plurality of movable parts 48 included on the external surface 26 of the device 12 may be designed to move when operated. However, this movement may simply be provided for play and tactile stimulation of the user, and thus not cause the interface component 28 to effect an operation on the smartphone 8.

FIG. 5A depicts a top view of the device 12, while FIG. 5B shows the device 12 from the front. In these views the front facing side of the viewfinder 32 is visible, through which a user may look to see an approximation of the image that will be captured by the camera on board the smartphone 8 if the control mechanism 24 is actuated. In FIG. 5B a front view of the second opening 20 is visible. When smartphone 8 is positioned in securing members 34 within interior 40 of the device 12, a rear facing camera 22 of the smartphone 8 (i.e., a camera with mounted to an opposite side of the smartphone 8 than the touchscreen 42) is positioned so as to face out of the second opening 20, as shown in dashed lines.

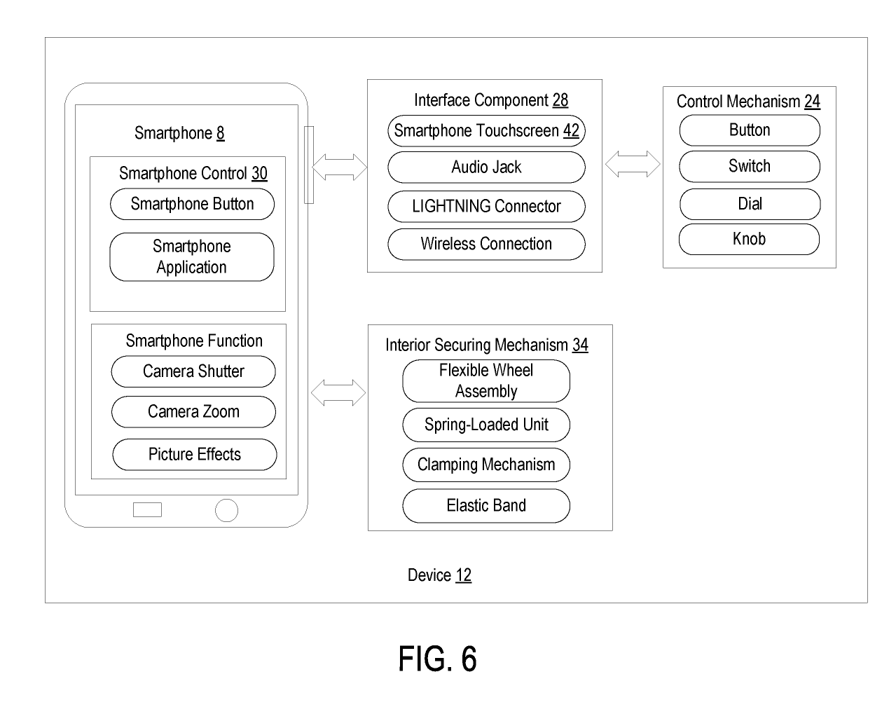

FIG. 6 is a schematic of the smartphone 8 and device 12 including the components described above listed as example implementations.

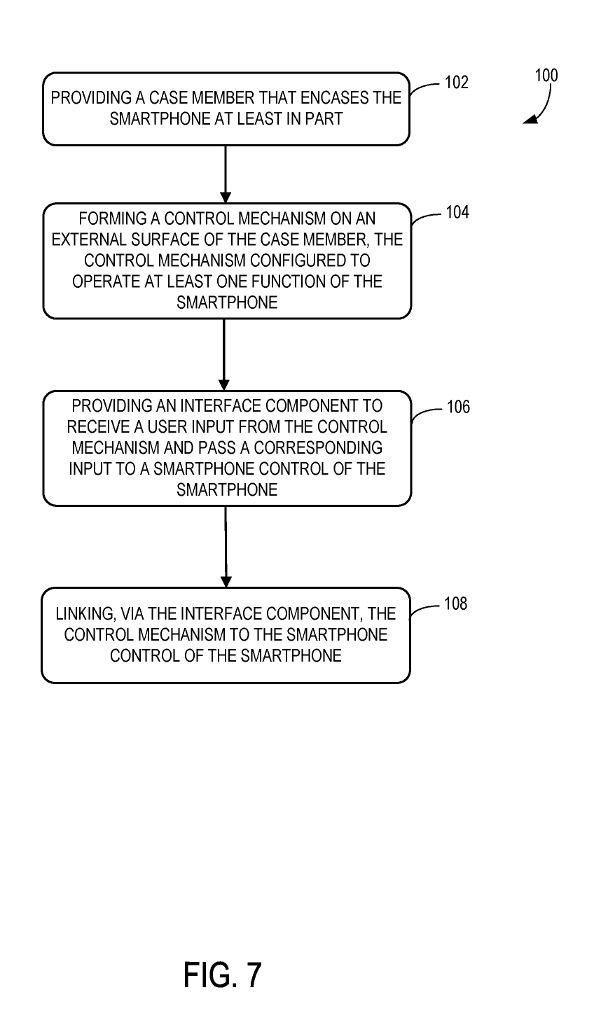

FIG. 7 illustrates a method 100 for manufacturing device 12 to encase a smartphone, the smartphone having an input component. At 102, the method 100 includes providing a case member 14 that encases the smartphone 8 at least in part. A first opening 16 that may be a first hole in the case member 14 may provide touch access to the smartphone 8 through a transparent window 18 that is a first unit. A second opening 20 that may be a second hole surrounding a camera lens 22 of the smartphone 8 may also be constructed. At 104, the method further includes forming a control mechanism 24 on an external surface 26 of the case member 14, the control mechanism 24 configured to operate at least one function of the smartphone 8. The method 100 at 106 may further include providing an interface component 28 to receive a user input from the control mechanism 24 and pass a corresponding input to a smartphone control 30 of the smartphone 8. At 108, the method 100 may further include linking, via the interface component 28, the control mechanism 24 to the smartphone control 30 of the smartphone 8.

Method 100 may include, as described above, the control mechanism 24 being one of a plurality of control mechanisms 24 on the external surface 26 of the case member 14, each configured to operate a respective one of a plurality of smartphone controls 30 via the interface component 28. The interface component 28 may be a touchscreen 42, an audio jack as depicted in FIGS. 2A and 3, a LIGHTNING connector, or a wireless connection such as BLUETOOTH. The control mechanism 24 may be a button that activates the function of the smartphone 8 via the interface component 28. Alternatively, the control mechanism 24 may be a switch, dial, knob, or other moving part synchronized with a function of the smartphone. The function of the smartphone 8 may be a shutter operation of a camera of the smartphone. A viewfinder 32 may be attached to the external surface 26 of the case member 14, the viewfinder 32 configured to allow a user to compose a picture to be taken via the camera of the smartphone 8. Additionally, an interior securing member 34 may be formed that is enclosed by the case member 14, the interior securing member 34 configured to adjustably encase a plurality of smartphone sizes. The interior securing member 34 is typically a centering clamp biased by spring as described above, but alternatively may be or include a flexible wheel assembly unit, a spring-loaded unit, a clamping mechanism, or at least one elastic band. The case member 14 may include at least a first part 36 and a second part 38 securely attached by an attachment mechanism in a manner that permits selective opening and closing of the first part 36 and second part 38. The attachment mechanism between the first part 36 and second part 38 typically includes a hinge 50 and one or more a latching mechanisms 52. The latching mechanisms include pins that are biased by coil springs. The pins may be depressed by a user (using finger engagable protruberances provided on the pins) against the coil springs to selectively release and engage the cover of the first part 36 to the second part 38 of the housing. The attachment mechanism may alternatively or additionally include a reusable adhesive mechanism and/or frictional contact. The first part 36 may open to an interior 40 of the device 12, within which a smartphone 8 may be secured and controlled via control mechanism 22 and interface component 28.

The device as described above has a potential advantage of harnessing smartphones to be utilized by younger users. Several features of the device are not only geared toward younger users but additionally facilitate transitioning between conventional smartphone use and modification of the smartphone to take advantage of those utilities that may be optimized for younger users. Securing the smartphone within the device allows a younger user to engage with features of the device in learning and play while accessing the smartphone camera or potentially other smartphone functions employed in games and activities through the device. Conventional smartphone users may easily remove the smartphone from the device and access full functionality that is blocked from younger users. Alternatively, the smartphone is equally easily returned to the device for a younger user to continue play and learning. The smartphone is not only secured within the device and protected from unwanted use by younger users, but the device physically protects the smartphone from damage and exposure that would otherwise be detrimental to a conventional smartphone. The device therefore functions to safely and efficiently facilitate employment of the smartphone, a single device, by a range of users.

Some of the process steps described and/or illustrated herein may, in some embodiments, be omitted without departing from the scope of this disclosure, and/or additional steps may be used. Likewise, the indicated sequence of the process steps may not always be required to achieve the intended results, but is provided for ease of illustration and description. One or more of the illustrated actions, functions, or operations may be performed repeatedly, depending on the particular strategy being used. It will be understood that the articles, systems, and methods described hereinabove are embodiments of this disclosure—non-limiting examples for which numerous variations and extensions are contemplated as well. This disclosure also includes all novel and non-obvious combinations and sub-combinations of the above articles, systems, and methods, and any and all equivalents thereof.

1. A device to encase a smartphone, the smartphone having an input component, the device comprising:
a case member that encases the smartphone at least in part, a first opening in the case member providing touch access to the smartphone through a transparent window and a second opening surrounding a camera lens of the smartphone; and
a control mechanism on an external surface of the case member linked via an interface component to a smartphone control of the smartphone and configured to operate at least one function of the smartphone, wherein the interface component is configured to receive a user input from the control mechanism and pass a corresponding input to the smartphone control of the smartphone.

2. The device of claim 1, wherein the control mechanism is one of a plurality of control mechanisms on the external surface of the case member, each configured to operate a respective one of a plurality of smartphone controls via the interface component.

3. The device of claim 1, wherein the interface component is at least one of the group consisting of a touchscreen, an audio jack, a LIGHTNING connector, and a wireless connection.

4. The device of claim 1, wherein the control mechanism is a button that activates the function of the smartphone via the interface component, and wherein the function of the smartphone is a shutter operation of a camera of the smartphone.

5. The device of claim 4, further comprising a viewfinder attached to the external surface of the case member, which is configured to allow a user to compose a picture to be taken via the camera of the smartphone.

6. The device of claim 1, further comprising an interior securing member enclosed by the case member, the interior securing member configured to adjustably encase a plurality of smartphone sizes and including at least one of the group consisting of a flexible wheel assembly unit, a spring-loaded unit, a clamping mechanism, and at least one elastic band.

7. The device of claim 1, wherein the case member includes at least a first part and a second part securely attached by at least one of the group consisting of a hinge, a latching mechanism, a pin, a reusable adhesive mechanism, and frictional contact and the first part opens to an interior of the device.

8. The device of claim 1, further comprising a sealing material on an interior of the case member configured to seal the interior of the device and protect the smartphone.

9. The device of claim 1, further comprising a protective cover positioned in at least one of the openings so as to cover a touchscreen of the smartphone.

10. The device of claim 1, further comprising the external surface of the device including at least one of the group consisting of rubber handles and a texture on the external surface of the device configured to increase friction between a user's hand and the device.

11. The device of claim 1, further comprising at least one bumper on the external surface of the device configured to absorb shock from impact forces.

12. The device of claim 1, wherein a movement of a plurality of movable parts included on the external surface of the device does not affect the interface component.

13. A method for manufacturing a device to encase a smartphone, the smartphone having an input component, the method comprising:
providing a case member that encases the smartphone at least in part, a first opening in the case member providing touch access to the smartphone through a transparent window and a second opening surrounding a camera lens of the smartphone;
forming a control mechanism on an external surface of the case member, the control mechanism configured to operate at least one function of the smartphone;
providing an interface component to receive a user input from the control mechanism and pass a corresponding input to a smartphone control of the smartphone; and
linking, via the interface component, the control mechanism to the smartphone control of the smartphone.

14. The method of claim 13, wherein the control mechanism is one of a plurality of control mechanisms on the external surface of the case member, each configured to operate a respective one of a plurality of smartphone controls via the interface component.

15. The method of claim 13, wherein the interface component is at least one of the group consisting of a touchscreen, an audio jack, a LIGHTNING connector, and a wireless connection.

16. The method of claim 13, wherein the control mechanism is a button that activates the function of the smartphone via the interface component, and wherein the function of the smartphone is a shutter operation of a camera of the smartphone.

17. The method of claim 16, further comprising attaching a viewfinder to the external surface of the case member, which is configured to allow a user to compose a picture to be taken via the camera of the smartphone.

18. The method of claim 13, further comprising forming an interior securing member enclosed by the case member, the interior securing member configured to adjustably encase a plurality of smartphone sizes and including at least one of the group consisting of a flexible wheel assembly unit, a spring-loaded unit, a clamping mechanism, and at least one elastic band.

19. The method of claim 13, wherein the case member includes at least a first part and a second part securely attached by at least one of the group consisting of a hinge, a latching mechanism, a pin, a reusable adhesive mechanism, and frictional contact and the first part opens to an interior of the device.

20. A device to encase a smartphone, the smartphone having an input component, the device comprising:
a case member that encases the smartphone at least in part, a first hole in the case member providing touch access to the smartphone through a transparent window and a second hole surrounding a camera lens of the smartphone; and
a control mechanism on an external surface of the case member linked via an interface component to a smartphone control of the smartphone and configured to operate at least one function of the smartphone, wherein the interface component is configured to receive a user input from the control mechanism and pass a corresponding input to the smartphone control of the smartphone, wherein
the control mechanism is a button that activates the function of the smartphone via the interface component, and
the function of the smartphone is a shutter of a camera of the smartphone.
